(19) United States
(12) Patent Application Publication
(10) Pub. No.: US 2007/0091170 A1
(43) Pub. Date: Apr. 26, 2007

(54) ENDOSCOPE SYSTEM

(75) Inventor: Noriko OTA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/551,447

(22) Filed: Oct. 20, 2006

(30) Foreign Application Priority Data
Oct. 21, 2005 (JP) P2005-307100

(51) Int. Cl. H04N 7/18

(52) U.S. Cl. 348/65

(57) ABSTRACT

An endoscope system includes an image signal processor and external devices connectable to the image signal processor. The external devices include an image output device and a monitor. The image signal processor includes an external device identifier for identifying the external device connected to the image signal processor, a first processing unit, and a second processing unit. The first processing unit processes the image signals to be first processed image signals for generating a first subject image output by the image output device, based on output characteristics data of the identified image output device. The second processing unit processes the image signals to be second processed image signals, based on monitor characteristics data of the identified monitor. The monitor can display a second subject image whose subject is the same as the first subject image, based on the second processed image signals.

### BACKGROUND OF THE INVENTION

1. Field of the Invention

The present invention relates to an endoscope system, especially to an endoscope system that enables correcting a subject image.

2. Description of the Related Art

In endoscopic observations, generally, an endoscope system includes an endoscope and external devices connected to the endoscope, including a monitor, a printer, and other devices. When a subject image is printed by a printer in such an endoscope system, the subject image, the printing menu, and other information are displayed on a monitor based on the image signals and other signals transmitted from the endoscope via the printer before printing the subject image. Therefore, a user can confirm the subject image to be printed, the printing menu, and other information.

When a printer and a monitor output images based on the same image signals, the qualities of images output by these devices are different each other, because the printer and the monitor may have different output characteristics for images. In terms of this point, in an endoscope system using a plurality of output devices, such a monitor and a printer for correcting the same image data in accordance with the output devices to maintain consistent image repeatability among the output devices is known. In such an endoscope system, an image transferred from one of the output devices to another output device can not be revised for output.

In a case where a subject image and so on are displayed on a monitor based on the image signals or other signals transmitted from the endoscope via the printer, the quality of the image on the monitor may deteriorate. The reason is that the monitor has different output characteristics for images from the printer. As a result, prompt operations for observing a subject, such as inserting a scope into or removing a scope from a body of a subject person may not be possible, because setting various conditions may be required for preventing the deterioration of the image quality reliably.

Even in an endoscope system where the same image data is corrected in accordance with each of the output devices (such as a printer or a monitor), when an image is displayed on a monitor based on the image signals that are transmitted from an endoscope via a printer, where the image signals are corrected for the printer, deterioration of the image quality for an image superimposed on the monitor may not be prevented.

### SUMMARY OF THE INVENTION

Therefore, an objective of the present invention is to provide an endoscope system that can reliably output a high quality image, even when the image data is transferred between different output devices in the endoscope system, regardless of the image output characteristics of the output devices.

An endoscope system, according to the present invention, includes an image signal processor and external devices. The image signal processor processes image signals of a subject. The external devices are connectable to the image signal processor. The external devices output a subject image based on the image signals processed by the image signal processor, and include an image output device and a monitor. The image signal processor includes an external device identifier, a first processing unit, a second processing unit, and a third processing unit. The external device identifier identifies the external device that is connected to the image signal processor. The first processing unit processes the image signals to be first processed image signals, based on output characteristics data representing the output characteristics of the image output device that is identified by the external device identifier, the first processed image signals being for generating a first subject image output by the image output device. The second processing unit processes the image signals to be second processed image signals, based on monitor characteristics data representing the output characteristics of the monitor that is identified by the external device identifier. The third processing unit converts the first processed image signals into the second processed image signals. The first processed image signals are transmitted from the first processing unit to the image output device and the third processing unit via the image output device. The second processed image signals that are converted from the first processed image signals received by the third processing unit are transmitted to the monitor, so that the monitor is able to display a second subject image that is a subject image of the same subject as the first subject image, and that corresponds to the second processed image signals.

The first processing unit may convert the second processed image signals into first processed image signals.

The endoscope system may further include a mode switch, which switches between a display mode where the monitor displays the IC second subject image, and a non-display mode where the monitor does not display the second subject image.

The monitor may be able further to display a message that indicates the image output device that is identified by the external device identifier.

A plurality of image output devices that are different from one another may be selectively connectable to the image signal processor, and the first processing unit may process the image signals based on the characteristics data of each of a plurality of the image output devices that are connected to the image signal processor.

The image output device may be a printer. The image signal processor may further include a data memory for storing the output characteristics data and the monitor characteristics data.

An image signal processor, according to the present invention, is for an endoscope, where external devices, including an image output device and a monitor, are connectable to the image signal processor. The image signal processor processes image signals for outputting a subject image by the external devices. The image signal processor includes an external device identifier, a first processing unit, and a second processing unit. The external device identifier identifies the external device that is connected to the image signal processor. The first processing unit processes the image signals to be first processed image signals, based on output characteristics data representing the output characteristics of the image output device that is identified by the external device identifier, the first subject image signals being for generating a first subject image output by the image output device. The second processing unit processes the image signals to be second processed image signals, based on monitor characteristics data representing the output characteristics of the monitor that is identified by the external device identifier. The first processed image signals are transmitted to the image output device, and the second processed image signals are transmitted to the monitor, so that the monitor can display a second subject image that is a subject image of the same subject as the first subject image, the second subject image corresponding to the second processed image signals.

### BRIEF DESCRIPTION OF THE DRAWINGS

The present invention will be better understood from the description of the preferred embodiment of the invention set forth below, together with the accompanying drawings, in which:

FIG. 1 is a block diagram of an endoscope system of the embodiment;

FIG. 2 is a block diagram of a secondary signal processing circuit and peripheral components surrounding the secondary signal processing circuit of the embodiment;

FIG. 3 is a block diagram of a reverse conversion circuit and peripheral components surrounding the reverse conversion circuit of the embodiment;

FIG. 4 is a flowchart of a printer output control routine representing a control of a subject image output from a processor to a printer in the endoscope system; and

FIG. 5 is a flowchart of a monitor output control routine representing a control of a subject image output from a processor to a monitor in the endoscope system.

### DESCRIPTION OF THE PREFERRED EMBODIMENT

Hereinafter, the preferred embodiment of the present invention is described with reference to the attached drawings.

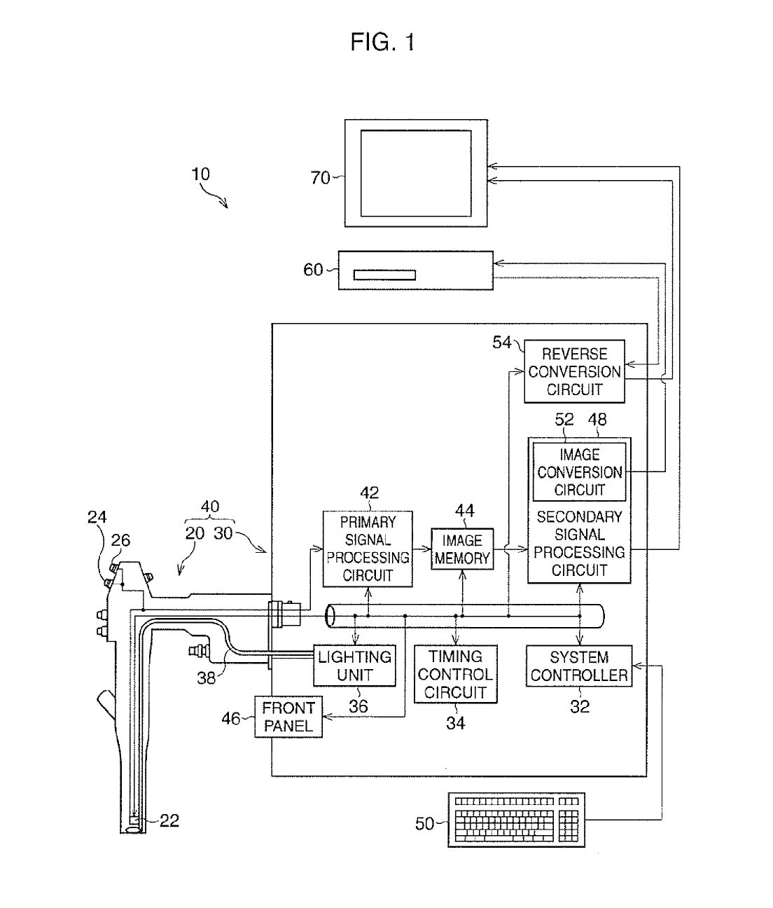

As shown in FIG. 1, an endoscope system 10 includes an endoscope 40, comprising a video scope 20 and a processor 30. The video scope 20 is used for photographing a subject (that is, inside a body cavity), and transfers image signals of a subject to the processor 30. The processor 30 processes image signals transferred from the video scope 20 to generate a subject image.

To the processor 30, a keyboard 50 for entering order signals and other information, a dye sublimation type printer 60 for printing a subject image and other documents, and a monitor 70 for displaying a subject image are connected. To the processor 30, a plurality of printers and monitors are connectable. In this embodiment, the printer 60 and the monitor 70, which are selected, are connected to the processor 30.

In the processor 30, a system controller 32 for controlling the entirety of the processor 30, a timing control circuit 34 for controlling signal processing timing in other circuits, a lighting unit 36 for emitting illuminating light, and other components are provided. On a surface of the processor 30, a front panel 46 is provided. On the front panel 46, a power switch (not shown) for switching the main power of the processor 30 on and off, and a light switch (not shown) for controlling the emission of illuminating light by the lighting unit 36 are provided.

A light source (not shown) in the lighting unit 36 emits illuminating light under the control of the system controller 32 when the light switch is switched on. The illuminating light enters a light guide 38 after its amount is adjusted. This illuminating light passes through the light guide 38, and is emitted to a body cavity of a subject from the end of the video scope 20.

The illuminating light reflected on a subject reaches a light-receiving surface of the CCD 22 at the end of the video scope 20, then image signals representing a subject are generated by the CCD 22. Further, the luminance signal Y and the color-difference signals Cb and Cr are generated by processing the image signals. The luminance signal Y and the color-difference signals Cb and Cr are transferred to a primary signal processing circuit 42, and are stored in an image memory 44 as digital image signals for each color of RGB (red, green, and blue), after further processes are carried out in the primary signal processing circuit 42.

Image signals, including the luminance signal Y and color-difference signals Cb and Cr, are output from the image memory 44 to the monitor 70 via a secondary signal processing circuit 48 (a “second processing unit”). As a result, a real-time moving image of a subject is displayed on the monitor 70.

A freeze button 24 is provided on the video scope 20. When the freeze button 24 is depressed while a moving image is displayed on the monitor 70, signals for generating a still image are transferred to the system controller 32, image signals are processed, and a still image is generated. The generated image data of a still image are stored in the image memory 44, and then transferred to the secondary signal processing circuit 48. In the secondary signal processing circuit 48, predetermined processes are carried out on the image data, and the image data are transferred to the monitor 70. As a result, a still image is displayed on the monitor 70.

Further, a copy button 26 is provided on the video scope 20, adjacent to the freeze button 24. The copy button 26 is used for commanding the printing of an image. That is, when the copy button 26 is depressed while a moving image is displayed on the monitor 70, command signals for commanding the printer 60 to print a still image of the subject displayed when the copy button 26 is depressed, are transferred to the system controller 32. As a result, image signals that are processed by predetermined processes are transferred to the printer 60 via an image conversion circuit 52 (a “first processing unit”) in the secondary signal processing circuit 48; then, the still image is printed.

In the embodiment, as explained below, image signals are processed in accordance with the output characteristics of each of the monitor 70 and the printer 60. That is, different processes of the same image signals for the same subject, for displaying the subject image on the monitor 70, and for printing the subject image by the printer 60, are carried out, respectively, by the secondary signal processing circuit 48, the image conversion circuit 52, and other components.

When a subject image is to be displayed on the monitor 70, image signals stored in the image memory 44 are processed by the secondary signal processing circuit 48, so that the image signals are converted to monitor image signals (“second processed image signals”). Then, the monitor image signals are transmitted to the monitor 70. On the other hand, when a subject image is to be printed by the printer 60, image signals are converted to monitor image signals first, the monitor image signals are further converted to printer image signals (“first processed image signals”) by the image conversion circuit 52, and then the printer image signals are transmitted to the printer 60. As a result, a first subject image, which is a subject image adjusted for the printer 60 is printed.

In the endoscope system 10, a print image display mode (a “display mode”) can be selected and set. In the print image display mode, the monitor 70 displays a second subject image, which is a subject image of the same subject as the first subject image to be printed by the printer 60, and which is a subject image adjusted to the monitor 70, before printing the first subject image by the printer 60. When the image display mode is set, the printer image signals are transmitted not only to the printer 60, but also to a reverse conversion circuit 54 (a “third processing unit”) provided in the processor 30, via the printer 60, from the output processing circuit 52.

The received printer image signals are converted into monitor image signals, which are adjusted to the output characteristics of the monitor 70, by the reverse conversion circuit 54. Then, by transmission of the monitor image signals to the monitor 70, the above-explained second subject image is displayed on the monitor 70 momentarily, prior to the printing of the first subject image by the printer 60.

As explained above, by transmitting the printer image signals not only to the printer 60, but also to a reverse conversion circuit 54, converting the received printer image signals into monitor image signals, and transmitting the monitor image signals to the monitor 70, the monitor 70 can display a second subject image which is adjusted to the monitor 70, and whose subject is the same as that of the first subject image to be printed by the printer 60.

On the other hand, in a current endoscope system, the reverse conversion circuit 54 is not provided, and image signals can not be processed similarly to the method used in this embodiment, so that printer image signals may be sent to a monitor via a printer. Then, as a result, an image of inferior quality may be displayed on a monitor.

Note that in the printer 60, a printing menu and so on can be set, therefore, in some cases, the image signals should be sent to the printer 60 for setting a printing menu. In such cases, in this embodiment, a second subject image that is suitable for the monitor 70 and that has the same subject as the first subject image to be printed can be displayed, as explained above.

On the other hand, in such cases, in a current endoscope system, an image which has inferior quality may be displayed on a monitor, because the printer image signals are transmitted to a monitor.

Note that the image display mode can be selected from menu items on the monitor 70 by operations of the keyboard 50, and when the image display mode is not selected, a print image non-display mode (a “non-display mode”), where the monitor 70 does not display the monitor subject image, is selected. In the image non-display mode, only a subject image based on the monitor image signals that are directly transmitted from the secondary signal processing circuit 48 to the monitor 70 is displayed, and the above-explained second subject image is not displayed.

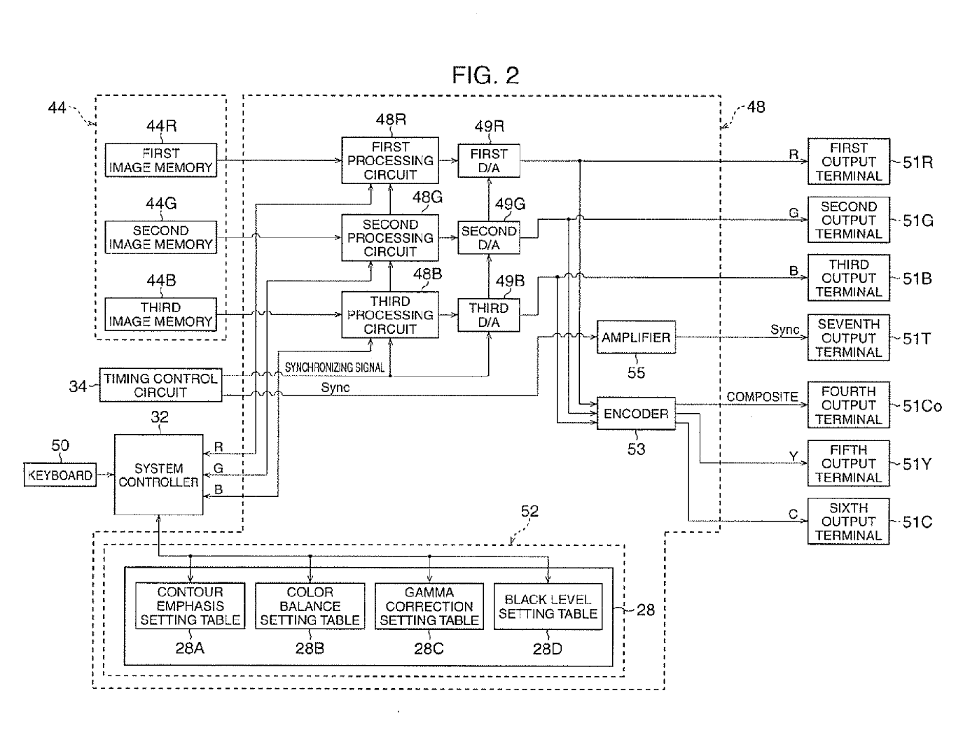

As shown in FIG. 2, in the image memory 44, a first image memory 44R in which red image signals are stored, a second image memory 44G in which green image signals are stored, and a third image memory 44B in which blue image signals are stored, are provided. In the image conversion circuit 52, there is provided a data memory 28, in which characteristics data representing the output characteristics of a plurality of the output devices, including the printer 60, which are connectable to the processor 30, are stored for each of the output devices. In the data memory 28, a contour emphasis setting table 28A, a color balance setting table 28B, a gamma correction setting table 28C, and a black level setting table 28D are stored.

Subject image signals read from the first to third image memories 44R, 44G, and 44B are input to each of first to third processing circuits 48R, 48G, and 48B. On the other hand, signals representing that the model of the output device connected to the processor 30 (that is, signals representing that the output device connected to the processor 30 is the printer 60) are input to the system controller 32 by operations of the keyboard 50.

When the system controller 32 receives the signals commanding printing of a subject image, each table stored in the data memory 26 is looked up based on the model represented by the above-explained signals, then the characteristics data representing the output characteristics of the output device of the model (that is, in this embodiment, the characteristics data of the printer 60) are read by the system controller 32. The read characteristics data are output to the first to third processing circuits 48R, 48G, and 48B as color control signals. In the first to third processing circuits 48R, 48G, and 46B, the color control signals are processed to improve the image quality of the subject image to be printed by the printer 60, in accordance with the output characteristics of the printer 60.

As explained above, in the endoscope system 10, a subject image having a suitable image quality is reproduced based on the output characteristics of the output device in use. However, image quality adjustment buttons (not shown) are provided on the printer 60 for adjusting the image quality as a user desires. Therefore, the image quality may be adjusted also by setting parameters using the image quality adjustment buttons, in terms of the items for which the characteristics data are set; that is, the color balance, the black level, or so on.

The color control signals are converted to analog pixel signals for each color, by the first to third D/A converters 49R, 49G, and 49B, provided in the secondary signal processing circuit 48. Analog pixel signals for each color component of RGB, which are output from the first to third D/A converters 49R, 49G, and 49B, are transmitted to the printer 60 via a cable driver (not shown) and first to third output terminals 51R, 51G, and 51B for outputting the RGB analog signals.

The analog pixel signals for each color component of RGB output from the first to third D/A converters 49R, 49G, and 49B are also input to an encoder 53. In the encoder 53, the luminance signals (Y), the color signals (C), and the NTSC composite video signals of which the luminance signals and color signals are composed, are generated based on the analog pixel signals for each color component of RGB. The luminance signals (Y), the color signals (C), and the NTSC composite video signals are transmitted to the printer 60 via the cable driver (not shown) and each of the corresponding fourth to sixth output terminals 51Co, 51Y, and 51C.

Further, synchronizing signals output from the timing control circuit 34 are amplified by the amplifier 55, and then transferred to the printer 60 via the cable driver (not shown) and the seventh output terminal 51T.

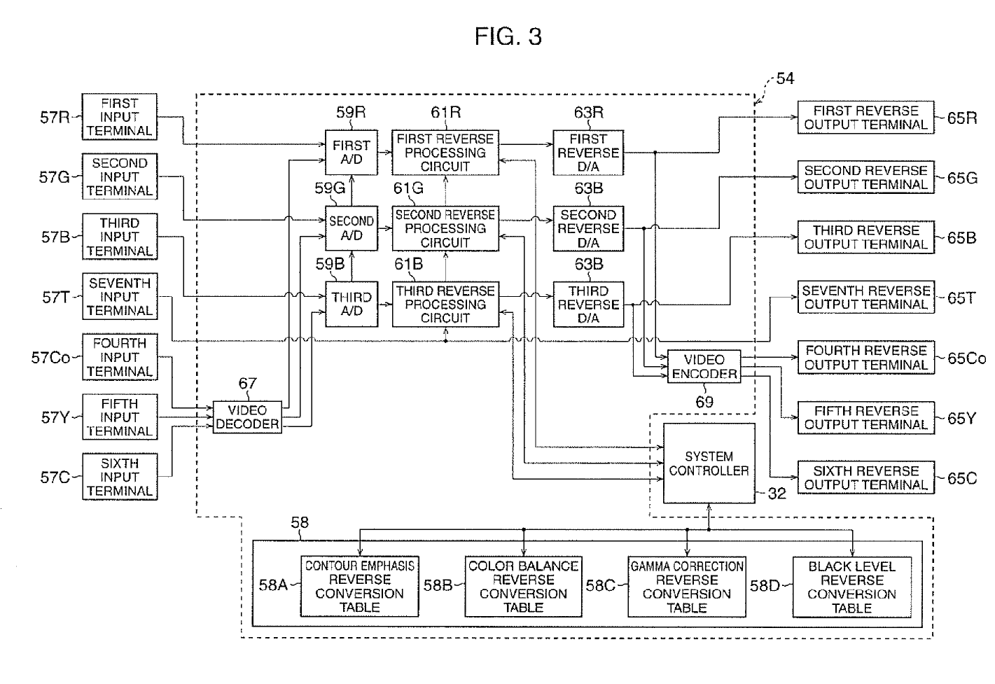

At that time, if the print image display mode is set, signals output from the first to seventh output terminals 51R, 51G, 51B, 51Co, 51Y, 51C, and 51T to the printer 60 are further input to the reverse conversion circuit 54, via the first to seventh input terminals 57R, 57G, 57B, 57Co, 57Y, 57C, and 57T (see FIG. 3).

In the reverse conversion circuit 54, a reverse data memory 58, in which reverse conversion data for converting image signals corrected in accordance with the output characteristics of the output device in use into original uncorrected image signals are stored for each of the output devices, is provided. In the reverse data memory 58, a contour emphasis reverse conversion table 58A, a color balance reverse conversion table 58B, a gamma correction reverse conversion table 58C, and a black level reverse conversion table 58D are stored.

Image signals input from the first to third input terminals 57R, 57G, and 57B, and image signals generated by the processing of the composite video signals, the luminance signals (Y), and the color signals (C) input from the fourth to sixth input terminals 57Co, 57Y, and 57C in the video decoder 67, are input to first to third A/D converters 59R, 59G, and 59B. Then, these image signals are converted to digital pixel signals for each color in the first to third A/D converters 59R, 59G, and 59B, and the digital image signals are output. These output digital pixel signals output from the first to third A/D converters 59R, 59G, and 59B are input to the first to third reverse processing circuits 61R, 61G, and 61B, respectively.

At that time, in the system controller 32, signals representing that the output device that is connected to the processor 32 is the printer 60 have already been input. Therefore, each table stored in the reverse data memory 58 is looked up, the reverse conversion data of the printer 60 are read, and then the read reverse conversion data are output to the first to third reverse processing circuits 61R, 61G, and 61B as color control signals, by the system controller 32. The color control signals are processed for reverse conversion in the first to third reverse processing circuits 61R, 61G, and 61B, to be restored to signals which were processed in the image conversion circuit 52 (see FIG. 2).

The processed color control signals are converted to analog pixel signals for each color in the first to third reverse D/A converters 63R, 63G, and 63B. The analog pixel signals for each color, output from the first to third reverse D/A converters 63R, 63G, and 63B, are transmitted to the monitor 70 via the cable driver (not shown) and each of the corresponding first to third reverse output terminals 65R, 65G, and 65B.

The analog pixel signals for each color component of RGB output from the first to third reverse D/A converters 63R, 63G, and 633 are also transmitted to a video encoder 69. In the video encoder 69, the luminance signals (Y), the color signals (C), and the NTSC composite video signals of which the luminance signals and color signals are composed, are generated based on the analog pixel signals for each color component of RGB. The composite video signals, the luminance signals (Y), and the color signals (C) are transmitted to the monitor 70 via the cable driver (not shown) and each of the corresponding fourth to sixth reverse output terminals 65Co, 65Y, and 65C.

Further, synchronizing signals, output from the printer 60 to the reverse conversion circuit 54 via the seventh input terminal 57T, are transferred to the monitor 70 from the seventh reverse output terminal 65T.

As explained above, in the endoscope system 10, the printer 60 can print a subject image that is adjusted to the output characteristics of the printer 60. Further, the monitor 70 can display the second subject image (that is, the subject image of the same subject as the first subject image to be printed by the printer 60, and which is a subject image adjusted to the monitor 70) before the second subject image is printed by the printer 60.

Note that when the print image display mode is set, on the monitor 70, a message, indicating that the output device connected to the processor 30 and in use is the printer 60, is displayed in addition to the above explained second subject image, under the control of the system controller 32. Further, parameters set in the printer 60 at that time, such as a parameter for the color balance, or for the black level, are also displayed on the monitor 70. Therefore, a user can adjust a subject image to be printed by confirming a screen on the monitor 70.

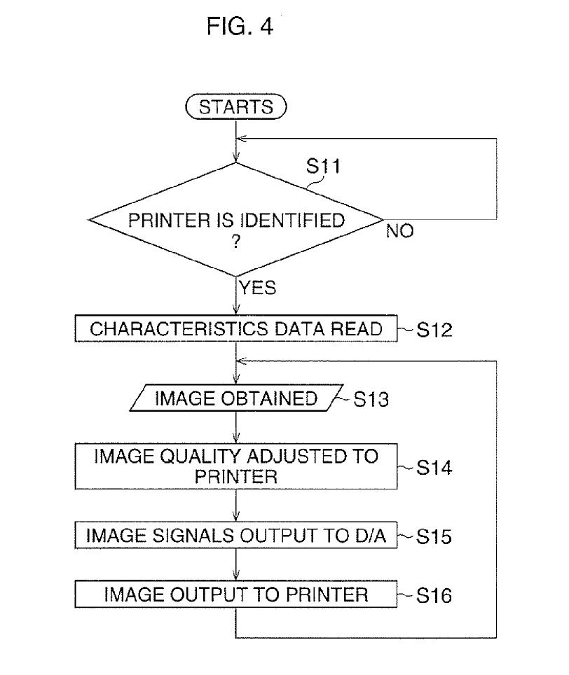

A printer output control routine (see FIG. 4) starts when the copy button 26 is depressed in the state where an output device, such as the printer 60, is connected to the processor 30. At step S11, whether the model name of the printer 60 connected to the processor 30 is entered by operations of the keyboard 50 or not (that is, whether the output device that is connected to the processor 30 is identified to be the printer 30 or not by the system controller 32) is determined. If it is determined that the model name is entered, the printer 30 is identified to be the output device connected to the processor 30, and the process proceeds to step S12. At step S12, the characteristics data of the printer 60 that are identified by the system controller 32 at step S11 are read from the data memory 28, and the process proceeds to step S13.

At step S13, image signals for each color component of RGB, stored in the image memory 44, are input to the secondary signal processing circuit 48, and then the subject image is obtained by the secondary signal processing circuit 48. At the following step S14, the image quality of the subject image is processed in the first to third processing circuits 48R, 48G, and 48B, based on the read characteristics data, so that the image quality is adjusted to be in accordance with the output characteristics of the printer 60. Then, the process proceeds to step S15.

At step S15, image signals processed in the first to third processing circuits 48R, 48G, and 48B are output to the first to third D/A converters 49R, 49C, and 49B, and the process proceeds to step S16. At step S16, the image signals further processed are output to the printer 60 via the first to third output terminals 51R, 51G, and 51B, then, the process returns to step S13.

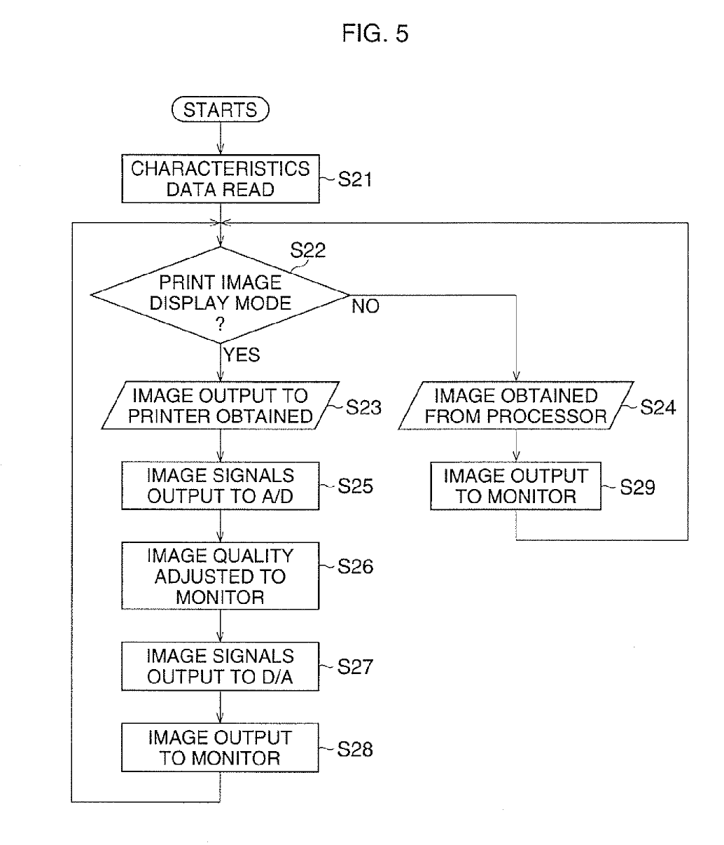

A monitor output control routine (see FIG. 5) starts when the model of the printer connected to the processor 30 is identified by operations of the keyboard 50. At step S21, the characteristics data of the printer 60 that is identified to be connected to the processor 30 are read from the data memory 28, and the process proceeds to step S22. At step S22, it is determined whether the print image display mode is set or not, by the system controller 32. If it is determined that the print image display mode is set, the process proceeds to step S23, and if it is not determined that the print image display mode is not set (that is, it is determined that the print image non-display mode is set), the process proceeds to step S24.

At step S23, the image output from the image conversion circuit 52 to the printer 60 is obtained by the reverse conversion circuit 54, and the process proceeds to step S25. At step S25, image signals are output to the first to third A/D converters 59R, 59G, and 59B in the reverse conversion circuit 54, via the first to third input terminals 57R, 57G, 57B, and other components, then, the process proceeds to step S26. At step S26, image signals are reverse converted by the first to third reverse processing circuits 61R, 61G, and 61B, to be restored to image signals before being processed by the image conversion circuit 52, and are thereby adjusted to the output characteristics of the monitor 70.

At the following step S27, the image signals on which the reverse conversion process has been carried out are output to the first to third reverse D/A converters 63R, 63G, and 63B, then, the process proceeds to step S28. At step S28, pixel signals are output to the monitor 70, and the process returns to step S22.

On the other hand, at step S24, because displaying the second subject image on the monitor 70 is not required, the monitor 70 directly obtains a subject image from the secondary signal processing circuit 48 in the processor 30, not via the printer 60. Then, the process proceeds to step S29. At step S29, the subject image is output by the monitor 70; that is, the subject image is displayed on the monitor 70. Then, the process returns to step S22.

As explained above, in the endoscope system 10 of the embodiment, subject images having an improved image quality in accordance with the output characteristics of each output device, including the printer 60, can be output by both the printer 60 and the monitor 70. This is achieved by storing the characteristics data of the printers that are connectable to the processor 30, such as the printer 60, in the processor 30, and by providing the reverse conversion circuit 54, to convert the image signals that are output to the printer 60 into image signals that are adjusted to the output characteristics of the monitor 70.

Note that a plurality of different monitors may also be connected to the processor 30 selectively as external devices, similarly to the printers. In such cases, not only the characteristics data for the printer 60, but also the characteristics data for all the usable monitors, such as the monitor 70, are pre-stored in the processor 30.

Output devices connected to the processor 30 and used therewith are not limited to printers such as the printer 60 and monitors such as the monitor 70; for example, a VCR (video cassette recorder) may be one of such output devices. The characteristics data may be stored in a memory that is outside the endoscope 40, instead of being stored in the data memory 28 inside the processor 30. In such a case, the characteristics data are read from the outside memory.

Further, identification information may be stored in the output devices, such as the printer 60 or the monitor 70, and then the output devices may be automatically identified when they are connected to the processor 30, by the system controller 32 reading the information, without any operations on the keyboard 50.

This invention is not limited to that described in the preferred embodiment, namely, various improvements and changes may be made to the present invention without departing from the spirit and scope thereof.

The present disclosure relates to subject matter contained in Japanese Patent Application No. 2005-307100 (filed on Oct. 21, 2005), which is expressly incorporated herein, by reference, in its entirety.

1. An endoscope system comprising:
an image signal processor that processes image signals of a subject; and
external devices that are connectable to said image signal processor, said external devices outputting a subject image based on said image signals processed by said image signal processor, said external devices including an image output device and a monitor;
said image signal processor comprising:
an external device identifier that identifies said external device that is connected to said image signal processor;
a first processing unit that processes said image signals to be first processed image signals, based on output characteristics data representing output characteristics of said image output device that is identified by said external device identifier, said first processed image signals being for generating a first subject image output by said image output device;
a second processing unit that processes said image signals to be second processed image signals, based on monitor characteristics data representing output characteristics of said monitor that is identified by said external device identifier; and
a third processing unit that converts said first processed image signals into said second processed image signals;
said first processed image signals being transmitted from said first processing unit to said image output device and said third processing unit via said image output device, and said second processed image signals converted from said first processed image signals received by said third processing unit being transmitted to said monitor, so that said monitor is able to display a second subject image that is a subject image of the same subject as said first subject image, said second subject image corresponding to said second processed image signals.

2. The endoscope system according to claim 1, wherein said first processing unit converts said second processed image signals into said first processed image signals.

3. The endoscope system according to claim 1, further comprising a mode switch that switches between a display mode where said monitor displays said second subject image, and a non-display mode where said monitor does not display said second subject image.

4. The endoscope system according to claim 1, wherein said monitor can further display a message that indicates said image output device that is identified by said external device identifier.

5. The endoscope system according to claim 1, wherein a plurality of said image output devices that are different from one another are selectively connectable to said image signal processor, and said first processing unit processes said image signals based on said characteristics data of each of a plurality of said image output devices that are connected to said image signal processor.

6. The endoscope system according to claim 1, wherein said image output device is a printer.

7. The endoscope system according to claim 1, wherein said image signal processor further comprises a data memory for storing said output characteristics data and said monitor characteristics data.

8. An image signal processor for an endoscope, where external devices include an image output device and a monitor connectable to said image signal processor, said image signal processor processing image signals for outputting a subject image by said external devices, said image signal processor comprising:
an external device identifier that identifies said external device that is connected to said image signal processor;
a first processing unit that processes said image signals to be first processed image signals, based on output characteristics data representing the output characteristics of said image output device that is identified by said external device identifier, said first subject image signals being for generating a first subject image output by said image output device; and
a second processing unit that processes said image signals to be second processed image signals, based on monitor characteristics data representing output characteristics of said monitor that is identified by said external device identifier;
wherein said first processed image signals are transmitted to said image output device and said second processed image signals are transmitted to said monitor, so that said monitor can display a second subject image that is a subject image of the same subject as said first subject image, said second subject image corresponding to said second processed image signals.
